(19) United States
(12) Patent Application Publication
(10) Pub. No.: US 2015/0004507 A1
(43) Pub. Date: Jan. 1, 2015

(54) FUEL CELL APPARATUS

(71) Applicant: KABUSHIKI KAISHA TOSHIBA, Minato-ku (JP)

(72) Inventors: Norihiro TOMIMATSU, Mitaka-shi (JP); Masato Akita, Yokohama-shi (JP); Ryosuke Yagi, Kawasaki-shi (JP)

(73) Assignee: KABUSHIKI KAISHA TOSHIBA, Minato-ku (JP)

(21) Appl. No.: 14/485,260

(22) Filed: Sep. 12, 2014

Related U.S. Application Data
(62) Division of application No. 14/259,937, filed on Apr. 23, 2014.
Application No. 14/259,937 is a continuation of application No. 12/054,845, filed on Mar. 25, 2008.

(30) Foreign Application Priority Data
Mar. 27, 2007 (JP) 2007-082646

(51) Int. Cl. H01M 8/04

(52) U.S. Cl. CPC H01M 8/04104; H01M 8/04902; H01M 8/04753; H01M 8/04873; H01M 8/04552
USPC 429/431; 429/432

(57) ABSTRACT

A fuel cell apparatus includes a fuel cell generating electric power, and including a fuel electrode which includes an anode catalyst, which is disposed in one side of an electrolyte membrane, which is supplied with liquid fuel, and which discharges gas generated by a chemical reaction accelerated by the anode catalyst, and an oxidizing agent electrode which includes a cathode catalyst, which is disposed in the other side of the electrolyte membrane, and which is supplied with air, and a control unit controlling a load applied to the fuel cell. The control unit increases the load in at least one of two cases, one case being when electric power generated by the fuel cell lowers below a predetermined reference value and another case being at predetermined time intervals, and stops the increase of the load after elapsing a predetermined time period from the start of the increase of the load.

### CROSS-REFERENCE TO RELATED APPLICATIONS

This application is a divisional of and claims the benefit of priority under 35 U.S.C. §120 from U.S. Ser. No. 14/259,937, filed Apr. 23, 2014, which is a continuation of U.S. Ser. No. 12/054,845, filed Mar. 25, 2008 and is based upon and claims the benefit of priority from prior Japanese Patent Application No. 2007-082646, filed Mar. 27, 2007, the entire contents of each of which are incorporated herein by reference.

### BACKGROUND OF THE INVENTION

1. Field of the Invention

This invention relates to a fuel cell apparatus including a fuel cell.

2. Description of the Related Art

A fuel cell has been known, which includes an electrolyte membrane, a fuel electrode including an anode catalyst and being disposed in one side of the electrolyte membrane, the fuel electrode being supplied with liquid fuel and discharging gas generated by a chemical reaction accelerated by the anode catalyst, and an oxidizing agent electrode including a cathode catalyst and being disposed in the other side of the electrolyte membrane, the oxidizing agent electrode being supplied with air. And, the fuel cell uses methanol-water solution obtained by diluting, for example, methanol (CH₃OH) with water (H₂O) by several % to several tens % as liquid fuel.

In such a conventional fuel cell, the methanol diluted solution of the liquid fuel supplied to the fuel electrode of the fuel cell from a liquid fuel tank through a liquid fuel supply path reacts to the catalyst (for example, mainly platinum (Pt) and ruthenium (Ru)) included in the fuel electrode in the following manner and releases carbon dioxide (CO₂), hydrogen ions (H⁺), and electrons (e⁻).

CH₃OH+H₂O→CO₂+6H⁺+6e−

The hydrogen ions (H⁺) permeate the electrolyte membrane from the fuel electrode side to the oxidizing agent electrode side, and react in the following manner to oxygen (O₂) in the air supplied to the oxidizing agent electrode of the fuel cell through an air supply path, by the catalyst (for example mainly platinum (Pt)) included in the oxidizing agent electrode to produce water (H₂O).

3/2O₂+6H⁺+6e⁻→3H₂O

The electrons (e⁻) move from an anode electrode toward a cathode electrode through an electric wire connecting the cathode electrode and the anode electrode to generate predetermined electric power.

The water produced at the oxidizing agent electrode is discharged to the outside of the fuel cell through a liquid discharge path, and is left as it is or returned to the liquid fuel tank. A fuel tank for replenishment storing methanol higher in concentration than the liquid fuel in the liquid fuel tank is connected to the liquid fuel tank. Then, when the methanol concentration of the liquid fuel in the liquid fuel tank becomes equal to or lower than a predetermined value, a predetermined amount of highly-concentrated methanol is replenished in the liquid fuel tank from the fuel tank for replenishment to return the methanol concentration of the liquid fuel in the liquid fuel tank to the predetermined value.

The carbon dioxide (CO₂) generated in the fuel electrode, together with unreacted liquid fuel in the fuel electrode, is discharged to the outside of the fuel cell through a liquid fuel return path. The outer end of the liquid fuel return path is connected to a gas-liquid separator, and the gas-liquid separator separates the carbon dioxide (CO₂) and the organic gas vaporized from the unreacted liquid fuel from the unreacted liquid fuel.

The unreacted liquid fuel mixed with the fresh liquid fuel is supplied again to the fuel electrode of the fuel cell through the liquid fuel supply path. The carbon dioxide (CO₂) and the organic gas are discharged to an outer space via an organic matter remover.

The fuel cell is combined with a liquid fuel forcibly-supplying unit such as an electric pump for supplying liquid fuel from the liquid fuel tank to the fuel electrode of the fuel cell through the liquid fuel supply path, an air forcibly-supplying unit such as an electric pump for supplying air to the oxidizing agent electrode of the fuel cell through the air supply path, a liquid fuel replenishing unit such as an electric pump for replenishing highly-concentrated liquid fuel from the fuel tank for replenishment to the liquid fuel tank, the gas-liquid separator, an auxiliary electric power source for compensating a fluctuation of electric power outputted from the fuel cell, a control unit for controlling operations of these auxiliary units, machinery and the like, and configures a fuel cell apparatus.

The fuel cell has such a problem that its output lowers gradually in accordance with elapsing of its operation time. This problem is thought to be caused by the following various reasons. That is, these reasons include clogging of the liquid fuel supply path or the air supply path, blocking of the air supply path in the catalytic electrode with water (flooding), poisoning of the catalyst in the fuel electrode (phenomenon of reducing a reacting sites on a catalyst surface due to a physical adsorption or chemical adsorption of an intermediate product or the like on the catalyst surface), oxidation of the catalyst in the oxidizing agent electrode, and the like.

Among these reasons, the oxidation of the catalyst in the oxidizing agent electrode surely occurs in a relatively-short time. JP-A-2005-149902 discloses a technique for deoxidizing the oxidized catalyst. By this technique, when electric power generated by the fuel cell lowers below a predetermined reference value or at predetermined time intervals, a load of the fuel cell is reduced to suppress generation of a reaction product accompanying electric power generation in the fuel cell while an amount of liquid fuel supplied by the liquid fuel forcibly-supplying unit is increased, and an amount of air supplied by the air forcibly-supplying unit is decreased, so that the reaction product is consumed to recover an output generated by the fuel cell.

### BRIEF SUMMARY OF THE INVENTION

According to one aspect of this invention, a fuel cell apparatus comprises: a fuel cell generating electric power, including an electrolyte membrane, a fuel electrode which includes an anode catalyst, which is disposed in one side of the electrolyte membrane, which is supplied with liquid fuel, and which discharges gas generated by a chemical reaction accelerated by the anode catalyst, and an oxidizing agent electrode which includes a cathode catalyst, which is disposed in the other side of the electrolyte membrane, and which is supplied with air; and a control unit controlling a load applied to the fuel cell. The control unit increases the load in at least one of two cases, one case being when electric power generated by the fuel cell lowers below a predetermined reference value and another case being at predetermined time intervals, and stops the increase of the load after elapsing a predetermined time period from the start of the increase of the load.

In at least one of two cases, one case being when electric power generated by the fuel cell lowers below a predetermined reference value and another case being at predetermined time intervals, the control unit increases the load to generate a state in which oxygen is insufficient in the oxidizing agent electrode of the fuel cell. As a result, oxygen bound to the catalyst of the oxidizing agent electrode is consumed and oxidation of the catalyst of the oxidizing agent electrode is reduced, so that the activity of the catalyst is recovered. The load increase is stopped after a predetermined time period which is thought to be required enough for recovering the fuel cell to generate an output (rated output) with a normal value has passed.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing the whole configuration of a fuel cell apparatus according to an embodiment of the present invention;

FIG. 2 is a view schematically showing an internal configuration of a control unit for controlling operations of various auxiliary units or machinery of the fuel cell apparatus in FIG. 1;

FIG. 3 is a graph showing a state in which an output lowers in a conventional fuel cell in accordance with a time elapsing and another state in which an operation for preventing conventional output lowering in the time elapsing has been performed in the fuel cell apparatus according to the embodiment of the present invention; and

FIG. 4 is a flowchart showing an example of a flow of the operation for preventing conventional output lowering in the time elapsing in the fuel cell apparatus according to the embodiment of the present invention.

### DETAILED DESCRIPTION OF THE INVENTION

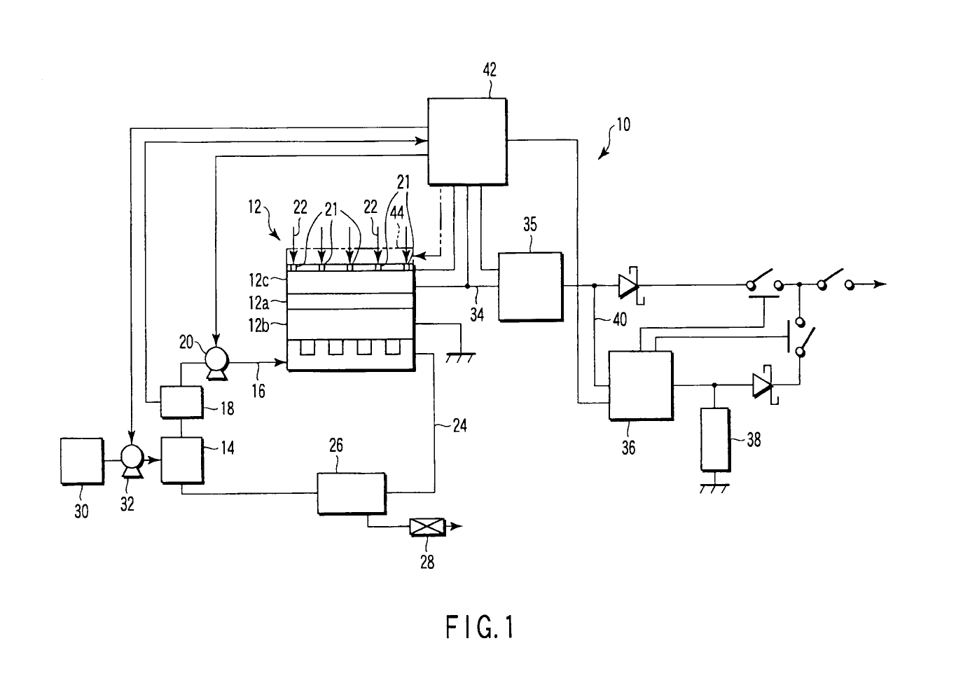

In FIG. 1, the whole configuration of a fuel cell apparatus 10 according to an embodiment of the present invention is schematically shown.

The fuel cell apparatus 10 is provided with a fuel cell 12. The fuel cell 12 includes an electrolyte membrane 12a, a fuel electrode 12b which includes an anode catalyst, which is disposed in one side of the electrolyte membrane 12a, which is supplied with liquid fuel, and which discharges gas generated by a chemical reaction accelerated by the anode catalyst, and an oxidizing agent electrode 12c which includes a cathode catalyst, which is disposed in the other side of the electrolyte membrane, and which is supplied with air. The fuel cell apparatus 10 uses methanol-water solution as liquid fuel to generate electric power. The methanol-water solution is obtained by diluting, for example, methanol (CH₃OH) with water (H₂O) by several % to several tens %. The electrolyte membrane 12a is provided by a polymer membrane with proton conductivity, for example. The fuel electrode 12b mainly includes platinum (Pt) and ruthenium (Ru), for example, as catalysts. Moreover, the oxidizing agent electrode 12c mainly includes platinum (Pt), for example, as a catalyst.

An extending end of a liquid fuel supply path 16 extending from a liquid fuel tank 14 is connected to the fuel electrode 12b. A liquid fuel concentration meter 18 and a liquid fuel forcibly-supplying unit 20 are interposed in the liquid fuel supply path 16. The liquid fuel concentration meter 18 measures the concentration of liquid fuel passing through the liquid fuel supply path 16. The liquid fuel forcibly-supplying unit 20 includes, for example, an electric pump and supplies liquid fuel forcibly from the liquid fuel tank 14 to the fuel electrode 12b of the fuel cell 12 through the liquid fuel supply path 16.

The oxidizing agent electrode 12c includes an air supply path and a drainage (not shown) communicating with the atmosphere. Air 22 is supplied naturally to the oxidizing agent electrode 12c by diffusion or convection through the air supply path.

The liquid fuel supplied from the liquid fuel tank 14 to the fuel electrode 12b through the liquid fuel supply path 16 by the liquid fuel forcibly-supplying unit 20 reacts in the following manner to the catalyst (for example, mainly platinum (Pt) and ruthenium (Ru)) included in the fuel electrode 12b and releases carbon dioxide (CO₂), protons (H⁺), and electrons (e⁻).

CH₃OH+H₂O→CO₂+6H⁺+6e⁻

The protons (H+) permeate the electrolyte membrane 12a from the fuel electrode 12b side to the oxidizing agent electrode 12c side, and react in the following manner by the catalyst (for example, platinum (Pt)) included in the oxidizing agent electrode 12c to oxygen (O₂) in the air supplied to the oxidizing agent electrode 12c through the air supply path to produce water (H₂O).

3/2O₂+6H⁺+6e⁻→3H₂O

The electrons (e⁻) flow outward from an anode of the fuel electrode 12b to generate predetermined electric power.

The water produced in the oxidizing agent electrode 12c is discharged to the outside of the fuel cell 12 through the drainage (not shown), and is left as it is or returned to the liquid fuel tank 14.

The carbon dioxide (CO₂) produced in the fuel electrode 12b, together with unreacted liquid fuel in the fuel electrode 12b, is discharged to the outside of the fuel cell 12 through a liquid fuel return path 24. An outer end of the liquid fuel return path 24 is connected to the liquid fuel tank 14 via a gas-liquid separator 26. The gas-liquid separator 26 separates the carbon dioxide (CO₂) from the unreacted liquid fuel which are delivered from the fuel electrode 12b via the liquid fuel return path 24. The gas-liquid separator 26 returns the separated and unreacted liquid fuel to the liquid fuel tank 14 through the liquid fuel return path 24, and releases the separated carbon dioxide (CO₂) and organic gas into the atmosphere through an organic matter removal device 28.

A fuel tank for replenishment 30 storing methanol higher in concentration than the liquid fuel in the liquid fuel tank 14 is connected to the liquid fuel tank 14. A liquid fuel replenishing unit 32 such as an electric pump, for replenishing highly-concentrated liquid fuel to the liquid fuel tank 14 from the fuel tank for replenishment 30, is interposed between the fuel tank for replenishment 30 and the liquid fuel tank 14.

An external output electric wire 34 extends from a cathode of the oxidizing agent electrode 12c. A DC/DC converter 35 is connected to the external output electric wire 34, and further a detouring electric path 40 accompanied with an auxiliary electric power source controller 36 and an auxiliary electric power source 38 is connected thereto. The auxiliary electric power source 38 can be a rechargeable secondary battery, a super capacitor or the like.

In this embodiment, the liquid fuel concentration meter 18, the liquid fuel forcibly-supplying unit 20, the gas-liquid separator 26, the liquid fuel replenishing unit 32, the DC/DC converter 35, and the auxiliary electric power source 38 accompanied with the auxiliary electric power source controller 36 are auxiliary units or machinery which are necessary for operating the fuel cell 12. These units or machinery, excepting the gas-liquid separator 26, and the fuel cell 12 are connected to a control unit 42 for controlling their operations.

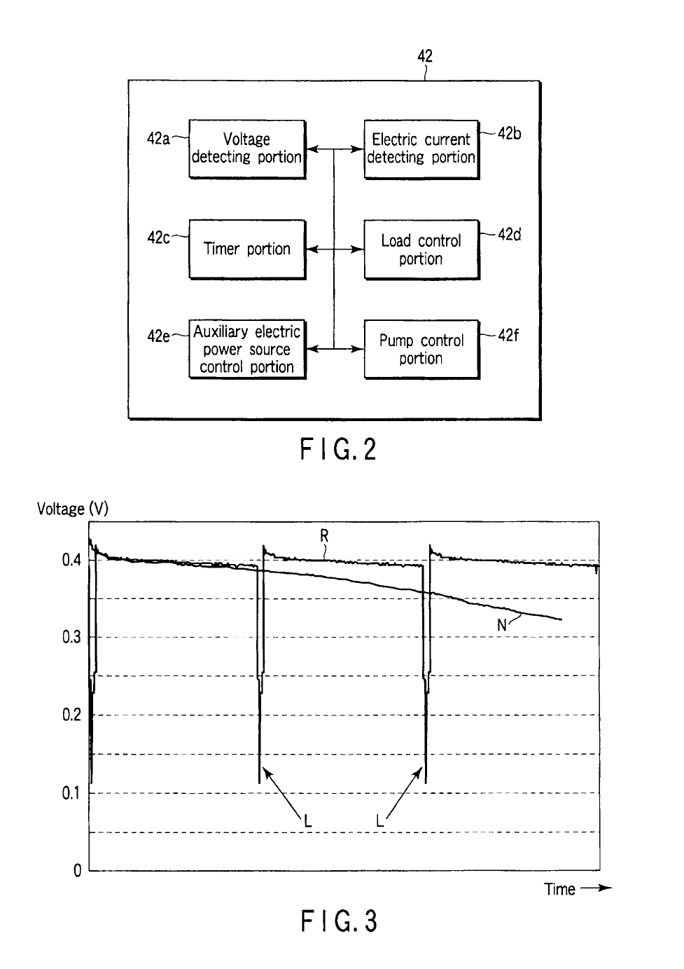

In FIG. 2, an internal configuration of the control unit 42 is schematically shown.

The control unit 42 is provided with a voltage detecting portion 42a, an electric current detecting portion 42b, a timer portion 42c, a load control portion 42d, an auxiliary electric power source control portion 42e, and a pump control portion 42f. The voltage detecting portion 42a detects the voltage of electricity outputted from the cathode of the oxidizing agent electrode 12c of the fuel cell 12. The electric current detecting portion 42b detects a load current of the abovementioned electricity. The timer portion 42c times the operating time of the fuel cell 12. The load control portion 42d controls load current of the fuel cell 12 via the DC/DC converter 35. The auxiliary electric power source control portion 42e controls a charging current supplied to the auxiliary electric power source 38 via the auxiliary electric power source controller 36. The pump control portion 42f is connected to the liquid fuel concentration meter 18 and controls the operations of the liquid fuel forcibly-supplying unit 20 and the liquid fuel replenishing unit 32.

The fuel cell apparatus 10 operates to cause the fuel cell 12 to output predetermined electric power (rated output).

When the liquid fuel forcibly-supplying unit 20 supplies a predetermined amount of liquid fuel per an unit time to the fuel electrode 12b of the fuel cell 12 from the liquid fuel tank 14 through the liquid fuel supply path 16, the fuel cell 12 outputs predetermined electric power from the cathode of the oxidizing agent electrode 12c, as described above. During this time, methanol in the liquid fuel supplied to the fuel electrode 12b of the fuel cell 12 from the liquid fuel tank 14 is consumed as described above. Therefore, the concentration of methanol in the liquid fuel returned to the liquid fuel tank 14 through the liquid fuel return path 24 from the fuel electrode 12b of the fuel cell 12 lowers gradually.

When the liquid fuel concentration meter 18 detects the fact that the concentration of methanol in the liquid fuel supplied to the fuel electrode 12b of the fuel cell 12 through the liquid fuel supply path 16 from the liquid fuel tank 14 lowers below a predetermined value, the pump control portion 42f of the control unit 42 operates the liquid fuel replenishing unit 32 for a predetermined time period. As a result, highly-concentrated liquid fuel is replenished for a predetermined time period into the liquid fuel tank 14 from the fuel tank for replenishment 30, and the concentration of methanol in the liquid fuel in the liquid fuel tank 14 is restored to an original predetermined value.

The best operational efficiency of the fuel cell 12 is achieved by operating the fuel cell 12 to generate electric power at a constant output (rated output). Therefore, the fuel cell 12 is designed such that an average power consumption of an electronic appliance assumed to be used and a rated output of the fuel cell 12 coincide with each other.

However, a power consumption of the electronic appliance or a power consumption of the electronic appliance connected to the distal end of the external output electric wire 34 of the fuel cell 12 may be increased temporarily. In this case, the control unit 42 controls the auxiliary electric power source controller 36 via the auxiliary electric power source control portion 42e to add auxiliary electric power from the auxiliary electric power source 38 to the external output electric wire 34 of the fuel cell 12.

Moreover, the power consumption of the electronic appliance or the power consumption of the electronic appliance connected to the distal end of the external output electric wire 34 of the fuel cell 12 may be decreased temporarily or lost completely. In this case, the control unit 42 controls the auxiliary electric power source controller 36 via the auxiliary electric power source control portion 42e to detour a part or all of the output from the fuel cell 12 to charge the auxiliary electric power source 38.

As described above in “BACKGROUND OF THE INVENTION” of this specification, the fuel cell 12 has the problem that the output of the fuel cell 12 lowers gradually in accordance with elapsing of its operation time as indicated by a reference character N in FIG. 3. Though this problem has been thought to be generated by various reasons, among these reasons, the oxidation of the catalyst in the oxidizing agent electrode 12c surely occurs in a relatively-short time. This time cycle changes depending on a kind or a performance of the fuel cell 12.

In order to solve the above described problem, in the fuel cell apparatus 10 according to this embodiment, the load control portion 42d of the control unit 42 increases the load of the fuel cell 12 in at least one of two cases, one case being when electric power generated by the fuel cell 12 lowers below a predetermined reference value and another case being at predetermined time intervals, and then stops the increase of the load after elapsing a predetermined time period from the start of the increase of the load.

Specifically, the load control portion 42d increases the load current to lower a voltage generated by the fuel cell 12 below a predetermined voltage, so that the load is increased.

More specifically, the load control portion 42d supplies at least a part of the electric power generated by the fuel cell 12 to the auxiliary electric power source 38, so that the load is increased.

Next, an example of a flow of an operation for preventing the conventional output lowering with time in the fuel cell apparatus 10 according to the embodiment of the present invention will be explained with reference to FIG. 1 to FIG. 4.

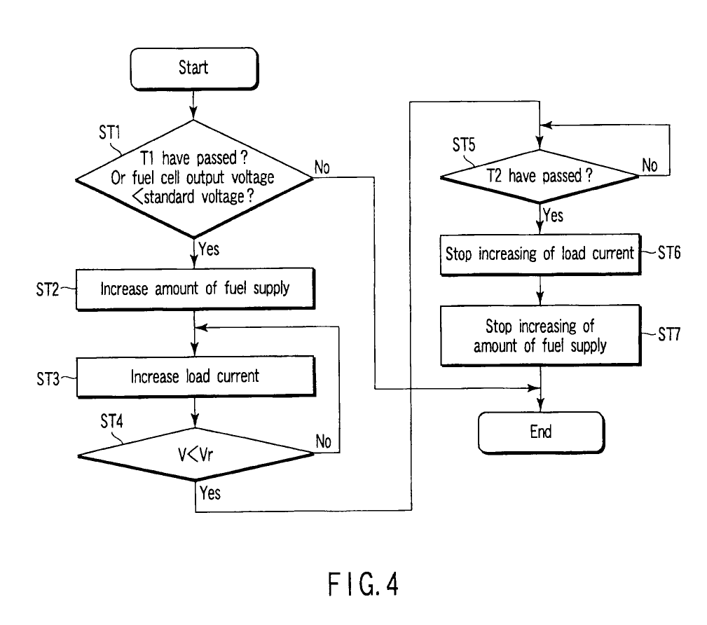

As shown in FIG. 4, at predetermined time intervals T1 from the operation start of the fuel cell apparatus 10, which is measured by the timer portion 42c of the control unit 42 (ST1), an amount of the liquid fuel supplied per an unit time to the fuel electrode 12b of the fuel cell 12 from the liquid fuel tank 14 is increased (ST2). This is for preventing fuel shortage in the fuel electrode 12b in a load current increase operation described later. If the fuel shortage occurs, polarity inversion occurs and the catalyst of the fuel electrode 12b is broken. Such increase of the supplying amount of fuel can be achieved by improvement of the operation of the liquid fuel forcibly-supplying unit 20 via the pump control portion 42f of the control unit 42 or replenishment of highly-concentrated liquid fuel to the liquid fuel tank 14 from the fuel tank for replenishment 30 by the liquid fuel replenishing unit 32. The operation for increasing the supplying amount of the fuel in such a manner can be omitted as long as the supplying amount of fuel is sufficient as compared to an amount of liquid fuel consumed in the fuel electrode 12b of the fuel cell 12 while the fuel cell apparatus 10 performs its rated operation, and further it is sure that fuel shortage in the fuel electrode 12b does not occur in the load current increase operation described later.

Next, as indicated by a reference character L in FIG. 3, the load current is increased by the load control portion 42d of the control unit 42 until the voltage (V) of the fuel cell lowers below a predetermined voltage (Vr) (ST3 and ST4).

As explained below, the predetermined voltage (Vr) is a value which generates an increase of the load current enough to consume (reduce) oxygen bound on the catalyst of the oxidizing agent electrode 12c of the fuel cell 12.

The increase of the load current cannot be performed by increasing a rated power consumption of an electric appliance (not shown) connected to an extending end of the external output electric wire 34 of the fuel cell apparatus 10. The increase of the load current is achieved by making the load control portion 42d control the auxiliary electric power source controller 36 via the auxiliary electric power source control portion 42e in the fuel cell apparatus 10 to charge the auxiliary electric power source 38.

When the load current is increased until the voltage (V) of the fuel cell 12 lowers below the predetermined voltage (Vr), the oxidizing agent electrode 12c of the fuel cell 12 is put into a state in which oxygen is insufficient. As a result, the oxygen bound on the catalyst of the oxidizing agent electrode 12c is consumed (reduced), the catalyst of the oxidizing agent electrode 12c recovers its activity.

When a predetermined time period T2 thought to be enough to perform the above reduction has passed (ST5), the load control portion 42d of the control unit 42 stops the above-described increase of the load current (ST6) and stops the increase of the supplying amount of liquid fuel (ST7).

As a result, as indicated by a reference character R in FIG. 3, electric power generated by the fuel cell 12 can be restored to a normal value (rated output) as an average value.

In this embodiment, as described above, the operation for increasing the load current is performed for the predetermined time period T2 at every predetermined time intervals T1. However, when an output voltage of the fuel cell 12 measured by the voltage detecting portion 42a of the control unit 42 lowers below a predetermined reference value, the operation for increasing the load current may be performed for the predetermined time period T2. The above predetermined reference value is set to a value which does not fall below a voltage reduction due to the conventional output lowering with time in the fuel cell 12 at the predetermined time intervals T1.

As described above, the fuel cell apparatus 10 according to the embodiment of this invention can recover from the output lowering with time in spite of the fact that an air forcibly-supplying unit such as an electric pump for supplying air forcibly through the air supply path to the oxidizing agent electrode 12b of the fuel cell 12 is not used.

Moreover, a supply air amount adjusting mechanism 44 such as an opening/closing shutter or a fan can be provided in the air supply path as shown by two—dots chain lines in FIG. 1. With such a configuration, when a state in which oxygen is insufficient in the oxidizing agent electrode 12c of the fuel cell 12 is created by increasing the load current as described above, reduction of a supply air amount or stop of air supply to the oxidizing agent electrode 12c can be easily performed by making the supply air amount adjusting mechanism 44 close the opening/closing shutter, reduce a rotation speed of the fan, or stop the rotation of the fan. This means that the state in which oxygen is insufficient in the oxidizing agent electrode 12c can be created more easily and efficiently. If opening and closing of the shutter is performed by the gravity or a combination of urging means such as a spring and an electric driving unit such as an electromagnet or a piston-solenoid mechanism the operation of which is controlled by the control unit 42, an increase of electric power used in the auxiliary units or machinery of the fuel cell apparatus 10 can be reduced as much as possible.

This invention can be applied to any fuel cell as long as it is a fuel cell using air as reactant, and as such a fuel cell, a solid polymer type fuel cell using, for example, hydrogen as a fuel or a fuel cell using liquid fuel such as ethanol, dimethyl alcohol, or borohydride can be used.

Moreover, as the auxiliary electric power source, various kinds of primary cells, a physical cell such as a solar cell or a thermal cell, or a combination of condensers with high capacitance can also be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1-12. (canceled)

13. A method of operating a fuel cell apparatus, the apparatus comprising an electrolyte membrane, a fuel electrode which includes an anode catalyst, which is disposed in one side of the electrolyte membrane and which is supplied with liquid fuel, and an oxidizing agent electrode which includes a cathode catalyst, which is disposed in the other side of the electrolyte membrane and which is supplied with air, the method comprising:
measuring a predetermined time lapse;
increasing a load electric current of the fuel cell apparatus after a lapse of the predetermined time;
measuring a voltage of the fuel cell apparatus and, in a case that the measured voltage of the fuel cell apparatus is higher than a first standard voltage, maintaining the increase of the load electric current of the fuel cell apparatus, and, in a case that the measured voltage of the fuel cell apparatus becomes lower than the first standard voltage, returning the load electric current of the fuel cell apparatus to a normal load electric current; and
restarting the measurement of the predetermined time lapse after the load electric current of the fuel cell apparatus returns to the normal load electric current.

14. The method according to claim 13, wherein increasing the load electric current of the fuel cell apparatus comprises supplying a part of an electric current generated by the fuel cell apparatus to an auxiliary electric power source.

15. The method according to claim 13, comprising:
increasing a fuel supply to an amount higher than a normal amount of fuel supply during the increasing of the load electric current of the fuel cell apparatus, and
returning the amount of the fuel supply to the normal fuel supply amount after the load electric current of the fuel cell apparatus is returned to the normal load electric current.

16. The method according to claim 13, comprising:
increasing the load electric current to a value greater than a normal load electric current.

17. A method of operating a fuel cell apparatus, the apparatus comprising an electrolyte membrane, a fuel electrode which includes an anode catalyst, which is disposed in one side of the electrolyte membrane and which is supplied with liquid fuel, an oxidizing agent electrode which includes a cathode catalyst, which is disposed in the other side of the electrolyte membrane and which is supplied with air, an air supply path for supplying air to the oxidizing agent electrode and a supply air amount adjusting mechanism provided in the air supply path,
the method comprising:
measuring a predetermined time lapse;
reducing or stopping an amount air supplied by the supply air amount adjusting mechanism through the air supply path after a lapse of the predetermined time;
measuring a voltage of the fuel cell apparatus and, in a case that the measured voltage of the fuel cell apparatus is higher than a first standard voltage, maintaining the reduction or the stoppage of the air supplied by the supply air amount adjusting mechanism through the air supply path, and, in a case that the measured voltage of the fuel cell apparatus is lower than the first standard voltage, returning the amount of air supplied to the fuel cell apparatus to a normal amount of air supply; and
restarting the measurement of the predetermined time lapse after a load electric current of the fuel cell apparatus returns to a normal load electric current.

18. A method of operating a fuel cell apparatus, the apparatus comprising an electrolyte membrane, a fuel electrode which includes an anode catalyst, which is disposed in one side of the electrolyte membrane and which is supplied with liquid fuel, and an oxidizing agent electrode which includes a cathode catalyst, which is disposed in the other side of the electrolyte membrane and which is supplied with air,
the method comprising:
measuring a voltage of the fuel cell apparatus and judging whether or not the measured voltage of the fuel cell apparatus is no more than a second standard voltage;
increasing a load electric current of the fuel cell apparatus in a case that the measured voltage of the fuel cell apparatus is no more than the second standard voltage;
maintaining an increase of the load electric current of the fuel cell apparatus in a case that the measured voltage of the fuel cell apparatus is higher than a first standard voltage, and
returning the load electric current of the fuel cell apparatus to a normal load electric current in a case that the measured voltage of the fuel cell apparatus becomes lower than the first standard voltage.

19. The method according to claim 18, wherein
increasing the load electric current of the fuel cell apparatus comprises supplying a part of an electric power generated by the fuel cell apparatus to an auxiliary electric power source.

20. The method according to claim 18, comprising:
increasing a fuel supply to an amount higher than a normal amount of fuel supply during the increasing of the load electric current of the fuel cell apparatus, and
returning the amount of the fuel supply to the normal fuel supply amount after the load electric current of the fuel cell apparatus is returned to the normal load electric current.

21. The method according to claim 18, comprising:
increasing the load electric current to a value greater than a normal load electric current.

22. A method of operating a fuel cell apparatus, the apparatus comprising an electrolyte membrane, a fuel electrode which includes an anode catalyst, which is disposed in one side of the electrolyte membrane and which is supplied with liquid fuel, an oxidizing agent electrode which includes a cathode catalyst, which is disposed in the other side of the electrolyte membrane and which is supplied with air, an air supply path for supplying air to the oxidizing agent electrode and a supply air amount adjusting mechanism provided in the air supply path,
the method comprising:
measuring a voltage of the fuel cell apparatus and judging whether or not the measured voltage of the fuel cell apparatus is no more than a second standard voltage;
reducing or stopping an amount air supplied by the supply air amount adjusting mechanism through the air supply path after a lapse of the predetermined time;
measuring the voltage of the fuel cell apparatus and, in a case that the measured voltage of the fuel cell apparatus is higher than a first standard voltage, maintaining the reduction of or the stoppage of the air supplied by the supply air amount adjusting mechanism through the air supply path, and, in a case that the measured voltage of the fuel cell apparatus becomes lower than the first standard voltage, returning the amount of air supplied to the fuel cell apparatus to a normal amount of air supply.
